(19) United States
(12) Patent Application Publication
(10) Pub. No.: US 2010/0138687 A1
(43) Pub. Date: Jun. 3, 2010

(54) RECORDING MEDIUM STORING FAILURE ISOLATION PROCESSING PROGRAM, FAILURE NODE ISOLATION METHOD, AND STORAGE SYSTEM

(75) Inventors: Yasuo NOGUCHI, Kawasaki (JP); Shunsuke Takagi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/569,219

(22) Filed: Sep. 29, 2009

(30) Foreign Application Priority Data
Nov. 28, 2008 (JP) 2008-304198

(51) Int. Cl. G06F 11/14; G06F 11/30

(52) U.S. Cl. 714/4; 714/47; 714/E11.113; 714/E11.179

(57) ABSTRACT

Slices obtained by dividing the real data storage area of the storage device by segments are assigned to each of a plurality of segments obtained by dividing a virtual logical volume as a primary slice storing data of the segment as a destination of access made by an access node and/or a secondary slice that mirrors and stores data of the primary slice. Management information associates the segment with the primary slice and the secondary slice. A survival signal transmitted at predetermined intervals while a computer is normally operating is monitored. The computer from which the survival signal is not detected over a predetermined time period is detected as a failure node. The failure node is checked against the management information, the managed slice is set as a single primary slice that is an access destination of the access node for which the mirroring is stopped. The failure node is isolated.

### CROSS-REFERENCE TO RELATED APPLICATIONS

This application is based upon and claims the benefit of priority of the prior Japanese Patent Application No. 2008-304198, filed on Nov. 28, 2008, the entire contents of which are incorporated herein by reference.

### FIELD

Various embodiments described herein relate to isolation of a failure node.

### BACKGROUND

In the past, distributed multi-node storage systems have been used as storage systems in order to increase the performance capabilities and the reliability by distributing a plurality of storage nodes on a network and making the storage nodes operate in concert with each other. In the multi-node storage system, a virtual logical volume is divided into segments so that the segments are distributed and stored in the storage nodes. The storage node divides a physical disk functioning as a live storage area into slices for management. Usually, the data is provided as redundant data so that a primary slice and a secondary slice are prepared for a single segment. Namely, the segment usually includes the primary slice and the secondary slice. The primary slice is a slice from and/or into which an access node processing an access request transmitted from an external terminal apparatus or the like directly reads and/or writes data. When data is written into the primary slice, the storage node mirrors the data to the secondary slice so that the data is written into the secondary slice. A slice for which no segment is assigned is managed as a free slice.

When a control node configured to manage the storage node detects a failure that occurs in the storage node, the control node performs recovery processing so that the segment where the failure occurs recovers (see WO/2004/104845, for example). The following processing is performed as the recovery processing.

(1) Detection of a failure that occurs in a storage node
(2) Isolation of a failure node
(3) Reassignment of a lost secondary slice and restarting of mirror writing
(4) Copying data to the reassigned slice

When the failure node includes the secondary slice when the failure node is isolated, mirror writing performed by a storage node having the primary slice of a segment that lost the secondary slice is stopped. Further, when the failure node includes the primary slice, the secondary slice of the segment that lost the primary slice is changed to the primary slice and the mirror writing is stopped.

During the recovery processing, access from multi-node storage is restarted when the failure node isolation described in (2) is finished. After that, the redundancy recovers when the data copying performed for a reassigned slice is finished.

However, it is difficult for the multi-node storages of the past to restart access until the control node isolates the failure node. Here, access processing performed for the segment will be described. FIG. 12 shows the operation sequence of the access processing.

Upon receiving a request to read data, the request being transmitted from an external terminal apparatus or the like, the access node issues a read request 901 for a disk node (P) having a primary slice. Upon receiving the request, the disk node (P) performs physical disk read processing 902 so as to read data from the primary slice. Then, the disk node (P) transmits the read data 903 to the request source via the access node. Thus, the read processing is terminated through processing performed between the access node and the disk node (P).

On the other hand, upon receiving a data write request, the access node issues a write request 911 to the disk node (P). Upon receiving the write request 911, the disk node (P) performs mirror writing 912 for the disk node (S) having the secondary slice. The disk node (S) updates the secondary slice by performing physical disk write processing 913, and transmits normal completion (OK) data 914 to the disk node (P) in return. Upon receiving the data 914, the disk node (P) updates the primary slice by performing physical disk write processing 915. After that, normal completion (OK) data 916 is transmitted to the request source via the access node. Thus, the write processing is not normally finished until the processing of not only the access node and the disk node (P), but also the disk node (S) having the secondary slice is finished.

Therefore, if an error occurs in the disk node (S), it becomes difficult to acquire the normal completion (OK) data 914 transmitted from the disk node (S). In that case, the write request 911 is not correctly terminated even though the disk node (P) functions normally. The above-described state continues until the disk node (S) where the failure had occurred is isolated.

However, since the entire processing that starts from the failure node detection and ends with to the failure node isolation is executed by the control node, it is difficult to perform the failure node isolation when the control node is stopped. Therefore, it becomes often difficult to restart access and a long time is often taken to restart the access even though the storage node functions normally, which impairs the service continuity.

Technologies disclosed herein have been achieved to reduce the above-described problems and present technologies relating to failure node isolation processing that allows for isolating a failure node without using a control node.

### SUMMARY

The first computer is a storage system in which data is distributed and stored in a plurality of storage devices, upon a failure occurring in a second computer managing a real data storage area of the storage device, the first computer isolates the second computer. Each of a plurality of slices obtained by dividing the real data storage area of the storage device by segments is assigned to each of a plurality of segments obtained by dividing a virtual logical volume as a primary slice storing data of each segment as a destination of access made by an access node and/or a secondary slice that mirrors and stores data of the primary slice. Management information associates the segment with the primary slice and the secondary slice is stored in a recording unit. An access request transmitted from the access node is processed based on the management information. A survival signal transmitted at predetermined intervals while the second computer is normally operating is monitored and the second computer from which the survival signal is not detected over a predetermined time period is detected as a failure node. A failure node isolation procedure where the failure node is checked against the management information, and when the slice to be managed is associated with the slice managed by the failure node, the slice to be managed is set as a single primary slice which is an access destination of the access node and for which the mirroring is stopped. The failure node is isolated.

Additional aspects and/or advantages will be set forth in part in the description which follows and, in part, will be apparent from the description, or may be learned by practice of the various embodiments.

### BRIEF DESCRIPTION OF DRAWINGS

FIG. 1 illustrates the general outlines of embodiments;

FIG. 2 illustrates an exemplary configuration of multi-node storage according to an embodiment;

FIG. 3 illustrates an exemplary hardware configuration of a disk node;

FIG. 4 illustrates an exemplary relationship between a logical volume and a disk;

FIG. 5A illustrates exemplary meta data of a disk node DP1;

FIG. 5B illustrates exemplary meta data of a disk node DP2;

FIG. 6A illustrates an exemplary format of a broadcast;

FIG. 6B illustrates a specific example of the broadcast;

FIG. 7 illustrates the operation sequence of failure node isolation processing;

FIG. 8 illustrates how meta data is updated when the disk node DP1 performs isolation processing;

FIG. 9 illustrates how meta data is updated when the disk node DP2 performs isolation processing;

FIG. 10 is a flowchart showing the procedures of failure node detection and the isolation processing;

FIG. 11 is a flowchart showing the procedures of failure node isolation processing; and

FIG. 12 illustrates the operation sequence of access processing.

### DESCRIPTION OF EMBODIMENTS

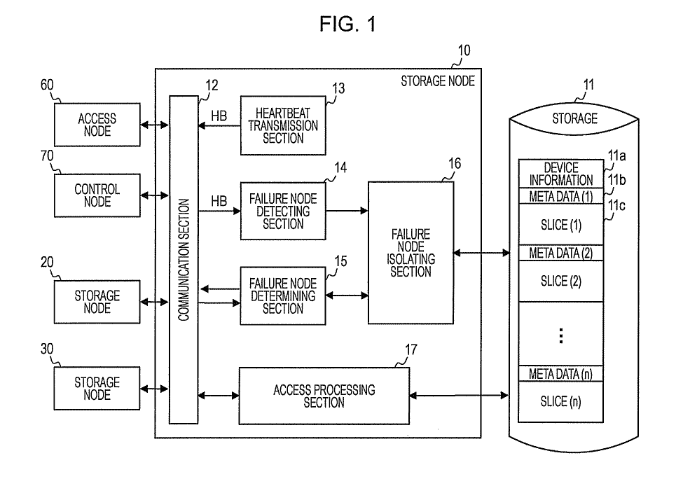

FIG. 1 shows the general outlines of embodiments. A storage node 10 is incorporated into a storage system including different storage nodes 20 and 30, an access node 60, and a control node 70, where the storage node 10 is connected to the above-described components via a network.

Each of the storage nodes 20 and 30 has the same configuration as that of the storage node 10. The storage nodes 20 and 30 manage the real data storage area corresponding to the logical volume of the storage system in concert with each other. The access node 60 issues a request to access the real data storage area managed by the storage nodes 10, 20, and 30 based on management information associating a virtual logical volume with the real data storage area.

The control node 70 dynamically controls the association between segments obtained by dividing the logical volume into data items of a predetermined size and individual slices obtained by dividing the real data storage area managed by the storage nodes 10, 20, and 30 into data items of the above-described predetermined size.

The configuration of the storage node 10 will be exemplarily described, so as to clarify that of each of the storage nodes 10, 20, and 30. The storage node 10 is connected to a storage device 11 and includes a communication section 12, a heartbeat transmission section 12, an error node detection section 14, a failure node determining section 15, a failure node isolating section 16, and an access processing section 17. Each of the storage devices has the same configuration as the storage node 10.

The storage device 11 is a real data storage area storing real data. The above-described real data storage area is divided into device information 11a including information about a device, n meta data items 11b including information about the slice, where the sign n denotes an arbitrary integer, and n slices 11c, where each of the slices 11c corresponds to the segment. For a single segment, the slice 11c is assigned two slices including a primary slice and a secondary slice so that redundancy is constituted. The primary slice is designated as the access destination of the access node 60, and stores the segment data. Data of the primary slice is mirrored to the secondary slice.

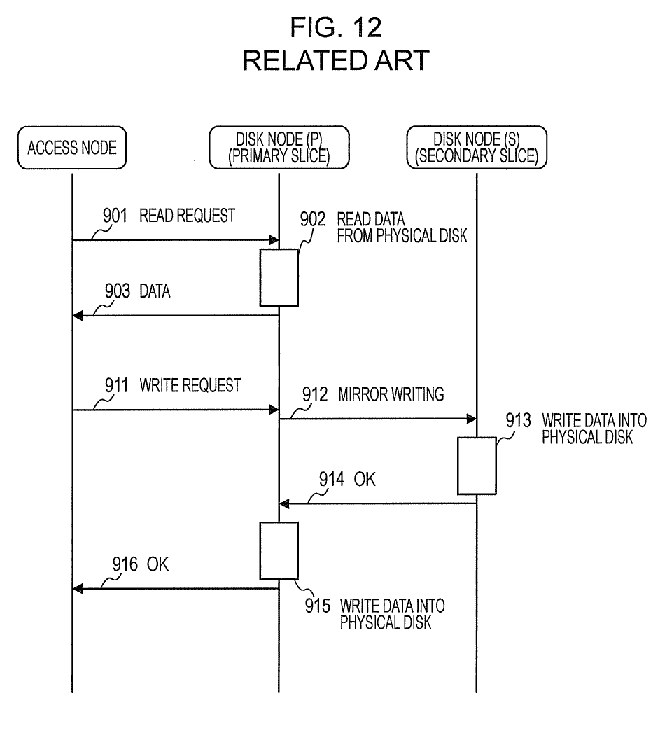

For a read request, the data of the primary slice is read and transmitted as a response, as illustrated in FIG. 12. Upon receiving a write request, mirroring is performed so that data is written into the secondary slice, and the data is written into the primary slice. The control node 70 can dynamically determine to which segment the slice should be associated, which of the primary slice and the secondary slice should be selected, and so forth. The storage node 10 can detect that a failure occurs in each of the different storage nodes 20 and 30, and change the slice state autonomously. The details of the above-described configuration will be described later. Each of the meta data items 11b is management information provided to manage each of the slices. Information is registered with the meta data 11b, where the information indicates to which of the segments the slice is assigned, whether the slice state indicates the primary slice or the secondary slice, the location of the slice subjected to the mirroring, and so forth.

The communication section 12 controls communications performed between the storage node 10, the different storage nodes 20 and 30, the access node 60, the control node 70, and so forth via a network (not shown).

The heartbeat transmission section 13 transmits heartbeat (HB) data provided as a survival signal at predetermined intervals. The HB data is transmitted through a broadcast that allows for transmitting data to an unspecified large number of people on the other end. The transmitted HB data is used by the different storage nodes 20 and 30, and the control node 70.

When the different storage nodes 20 and 30 monitor the transmitted HB data and if there is a storage node from which no HB data is detected over a predetermined time period, the failure node detecting section 14 determines the above-described storage node to be a failure node. Here, the detected failure node may be determined to be a candidate for the failure node and determining processing may be performed through the failure node determining section 15 as appropriate.

The failure node determining section 15 notifies the different storage nodes 20 and 30 of the detected failure node candidate through a broadcast. If a failure node candidate is detected in a like manner through each of the different storage nodes 20 and 30, a notification is transmitted through a broadcast. Subsequently, the failure node determining section 15 extracts data of the failure node candidate from the failure-node-candidate notification transmitted from each of the different storage nodes 20 and 30, and checks the extracted failure-node-candidate data against failure-node-candidate data detected through the failure node determining section 15. If the extracted candidate data matches with the detected candidate data, the failure node candidate is determined to be a failure node.

The failure node isolating section 16 isolates the failure node detected by the failure node detecting section 14 and/or the failure node that is detected by the failure node detecting section 14 as the failure node candidate and that is determined to be the failure node through the failure node determining section 15. Data of the storage node of a slice provided at a mirror destination is registered with the meta data. Namely, if the slice is the primary slice, data of the storage node of the secondary slice for association is registered with the meta data. If the slice is the secondary slice, data of the storage node of the primary slice for association is registered with the meta data. Here, the failure node isolating section 16 checks the detected failure node data against data of the storage node of the mirror destination of the slice of the failure node isolating section 16 so as to determine whether or not the above-described nodes match with each other.

If the above-described nodes match with each other, the failure node isolating section 16 determines the above-described slice to be a single primary slice. The single primary slice denotes a primary slice including no slice for mirroring. Although the single primary slice becomes the access destination of the access node 60, no mirroring is performed for the slice for mirroring (the associated secondary slice). Consequently, the failure node is isolated so that the access node 60 can make access.

The access processing section 17 processes data of an access request transmitted from the access node 60. If the access request is a read request, the access processing section 17 reads data from the primary slice for which the access request is issued and transmits a response. If the access request is a write request and a target slice is the primary slice, the access processing section 17 transmits a write request to a slice functioning as a mirror of the primary slice. If a normal response is obtained, data is written into the primary slice and transmits response data to the access node 60. If the access request is the write request and the target slice is the single primary slice, the access processing section 17 performs nothing except writing data into the single primary slice, and transmits response data to the access node 60. If it is difficult to transmit an access request to the storage node of the access request destination, the access node 60 specifies a segment for a different storage node and issues a request to read the meta data. If data of a response to the read request includes the meta data corresponding to the specified segment, the access processing section 17 transmits the above-described meta data to the access node 60. If the response data does not include the corresponding meta data, the access processing section 17 transmits a request to read the meta data of the specified segment to a different storage node through a broadcast.

Consequently, the meta data is transmitted from the storage node having the corresponding meta data through a broadcast. The access processing section 17 transmits the meta data transmitted in the above-described manner to the access node 60. If the meta data is changed through the failure node isolating section 16, the changed meta data is transmitted to the access node 60. From then on, the access node 60 can make access based on the acquired meta data. The meta data that is autonomously changed through the storage nodes 10, 20, and 30 can be transmitted to the access node 60 without using the control node 70.

Failure node isolation processing and a failure node isolation method that are provided for a multi-node storage system having the above-described storage nodes will be described. The storage nodes 10, 20, and 30 transmit the HB data to one another at regular time intervals. If a failure occurs in the storage node 20 under the above-described circumstances, the transmission of the HB data items is interrupted and the storage node 20 is detected as a failure node through the failure node detecting section 14. At that time, each of the storage nodes 10 and 30 detects the storage node 20 as a candidate for the failure node and transmits a notification about the detection through a broadcast. The storage node 10 is notified by the storage node 30 that the storage node 20 is detected as the failure node candidate. Since the notification transmitted from the storage node 30 matches with the failure node candidate detected through the failure node detecting section 14, the failure node determining section 15 determines the storage node 20 to be the failure node.

The failure node isolating section 16 checks the meta data and extracts a slice using the storage node 20 determined to be the failure node as the slice of a mirror destination. If the slice is extracted, the slice is changed to the single primary slice and the meta data is updated. Consequently, a slice managed by the failure node is isolated so that the access node 60 can make access. Before the slice is changed to the single primary slice, a read request can be issued when a failure occurs so long as the above-described slice is the primary slice. However, a write request is transmitted with difficulty under the same circumstances. Since the above-described slice is changed to the single primary slice, mirroring performed for the lost secondary slice is stopped. Therefore, the write request issued by the access node 60 can be appropriately completed. Before the slice is changed to the single primary slice, it becomes difficult to issue the read request and the write request when a failure occurs so long as the above-described slice is the secondary slice. Since the above-described slice is changed to the single primary slice, the primary slice is provided in place of the lost primary slice and the mirroring is stopped. Therefore, the read request and the write request that are transmitted from the access node 60 can be appropriately completed.

Thus, it becomes possible to detect the failure node and isolate the failure node autonomously through the use of the slice node alone. Further, the meta data can be referred to through the access node even though a permanently stationing control node is not provided. As a result, it becomes possible to reduce situations where access is made with difficulty and increase the service continuity.

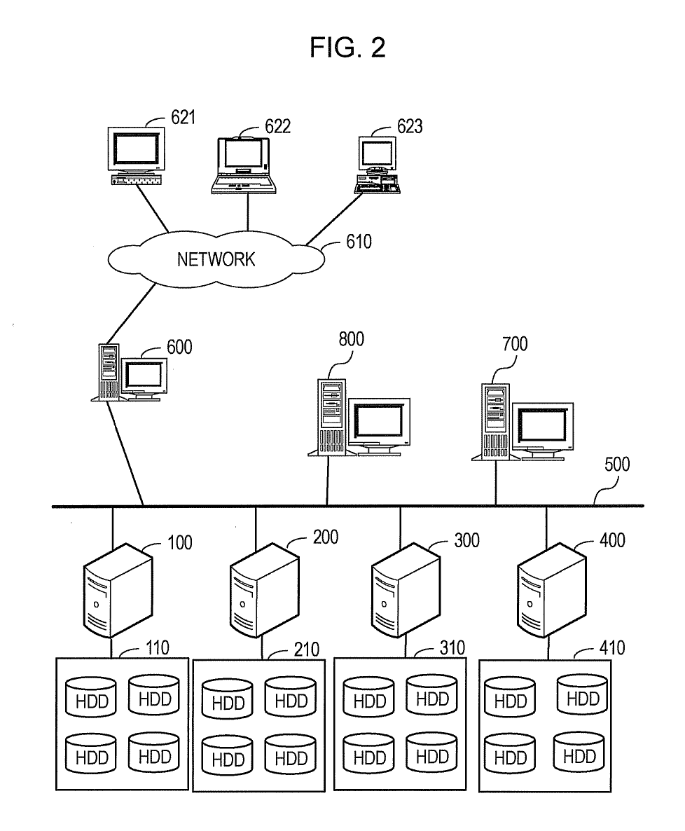

Hereinafter, embodiments of the present invention will be described in detail. FIG. 2 shows an exemplary configuration of multi-node storage according to an embodiment of the present invention. The multi-node storage is connected to a plurality of disk nodes 100, 200, 300, and 400, and an access node 600, a control node 700, and a management node 800 via a network 500.

A disk 110 is connected to the disk node 100, a disk 210 is connected to the disk node 200, a disk 310 is connected to the disk node 300, and a disk 410 is connected to the disk node 400. A plurality of hard disk devices (HDDs) is implemented on the disk 110. Each of the disks 210, 310, and 410 has the same configuration as that of the disk 110. Each of the disk nodes 100, 200, 300, and 400 is a computer having an architecture referred to as Intel Architecture (IA). The disk nodes 100, 200, 300, and 400 individually manage data items stored in the disks 110, 210, 310, and 410 that are individually connected thereto so that the managed data is presented to terminal apparatuses 621, 622, and 623 via the access node 600. Further, in each of the disk nodes 100, 200, 300, and 400, the same data is managed by at least two disk nodes, so as to manage redundant data. According to the above-described embodiment, storage nodes performing the failure node isolation processing, as is the case with FIG. 1, are presented as the disk nodes 100, 200, 300, and 400.

The plurality of terminal apparatuses 621, 622, and 623 is connected to the access node 600 via a network 610. The access node 600 perceives the storage location of data managed by each of the disk nodes 100, 200, 300, and 400, and makes data access to the disk nodes 100, 200, 300, and 400 in response to a request transmitted from each of the terminal apparatuses 621, 622, and 623.

The control node 700 manages the disk nodes 100, 200, 300, and 400. For example, the control node 700 monitors HB data transmitted from each of the disk nodes 100, 200, 300, and 400, and performs recovery processing if an error is detected from any of the disk nodes 100, 200, 300, and 400.

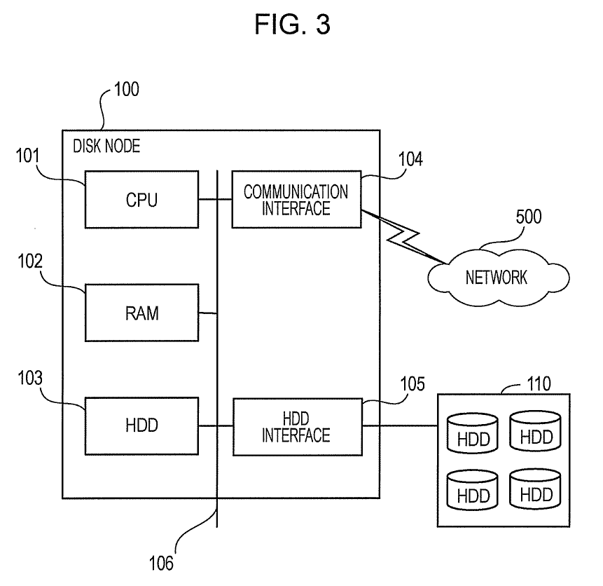

A management node 800 manages the entire multi-node storage system. FIG. 3 shows an exemplary hardware configuration of the disk node. The entire disk node 100 is controlled by a central processing unit (CPU) 101. The CPU 101 is connected to a random access memory (RAM) 102, an HDD 103, a communication interface 104, and an HDD interface 105 via a bus 106.

The RAM 102 temporarily stores at least part of an operating system (OS) and/or application programs executed by the CPU 101. Further, the RAM 102 stores various data used by the CPU 101 performing processing. The HDD 103 stores the programs of the OS and/or applications. The communication interface 104 is connected to a network 500. The communication interface 104 transmits and/or receives data to and/or from different computers that are included in the multi-node storage system via the network 500, where the different computers include a different disk node, the access node 600, the control node 700, the management node 800, and so forth. The HDD interface 105 performs processing so as to make access to the HDD included in the disk 110.

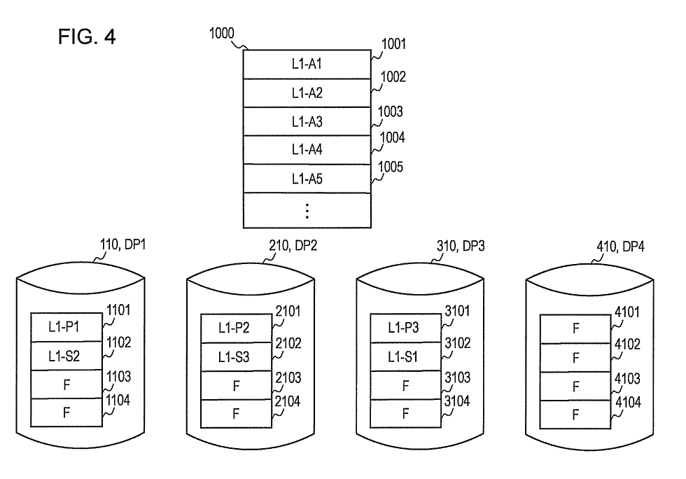

Here, the relationships between a logical volume and the disks 110, 210, 310, and 410 will be described. FIG. 4 shows an exemplary relationship between the logical volume and the disks 110, 210, 310, and 410.

A virtual logical volume 1000 is divided into segments 1001, 1002, 1003, 1004, and 1005 for management. Each of the above-described segments is provided with identification information used to identify the segment. In the above-described embodiment, identification information including data of the name and the address of the logical volume is provided for each of the segments. For example, identification information L1-A1 is set based on a logical volume name L1 and an address A1 for the segment 1001. Similarly, identification information L1-A2, identification information L1-A3, identification information L1-A4, and identification information L1-A5 are set for the individual segments 1002, 1003, 1004, and 1005.

In each of the disks 110, 210, 310, and 410 functioning as real data storage areas, the storage area is divided into slices for management. According to FIG. 4, the disk 110 includes slices 1101, 1102, 1103, and 1104. The disk 210 includes slices 2101, 2102, 2103, and 2104. The disk 310 includes slices 3101, 3102, 3103, and 3104. Further, the disk 410 includes slices 4101, 4102, 4103, and 4104. Each of the slices is assigned a segment through the control node 700. According to FIG. 4, the segment [L1-A1] 1001 is assigned the slice 1101 of the disk 110 and the slice 3102 of the disk 310. In FIG. 4, a primary slice is designated by the sign P and a secondary slice is designated by the sign S. The sign [L1-P1] of the slice 1101 of the disk 110 indicates that the slice 1101 is a primary slice associated with the segment [L1-A1]. Similarly, the sign [L1-S1] of the slice 3102 of the disk 310 indicates that the slice 3102 is a secondary slice associated with the segment [L1-A1]. Further, the sign [F] indicates that the slice is in the free state, which means that the slice is assigned no segment. As shown in FIG. 4, the primary slice and the secondary slice that correspond to a single segment are provided in different disks.

For example, the primary slice of the segment [L1-A1] 1001 is the slice [L1-P1] 1101 of the disk 110, and the secondary slice of the segment [L1-A1] 1001 is the slice [L1-S1] 3102 of the disk 310. The primary slice of the segment [L1-A2] 1002 is the slice [L1-P2] 2101 of the disk 210, and the secondary slice of the segment [L1-A2] 1002 is the slice [L1-S2] 1102 of the disk 110. Similarly, the primary slice of the segment [L1-A3] 1003 is the slice [L1-P3] 3101 of the disk 310, and the secondary slice of the segment [L1-A3] 1003 is the slice [L1-S3] 2102 of the disk 210.

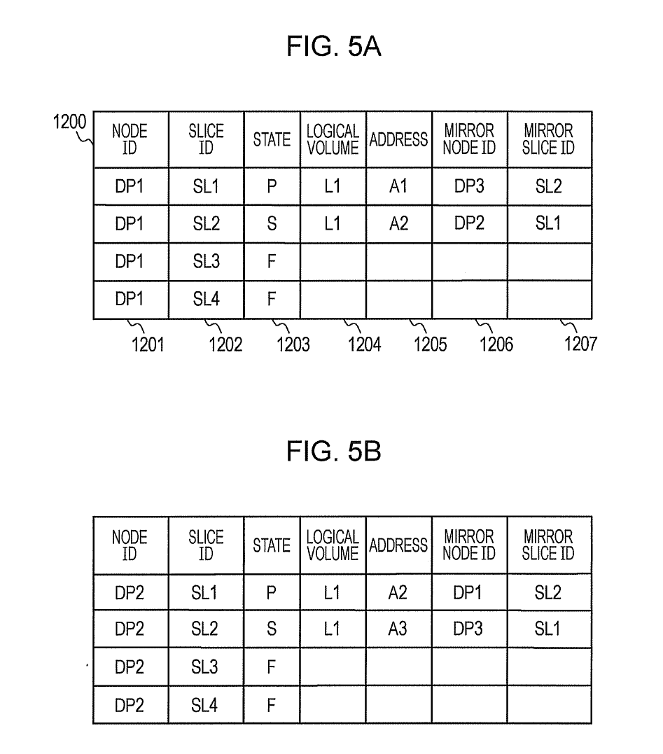

The above-described relationships between the segments, the primary slices, and the secondary slices are described in the meta data. FIG. 5A shows exemplary meta data of a disk node DP1. FIG. 5B shows exemplary meta data of a disk node DP2. Here, the slices of the disk nodes DP1 and DP2 are assigned the segments shown in FIG. 4.

(A) Meta data 1200 of the disk node DP1 has information items including node ID data 1201, slice ID data 122, state data 1203, logical volume data 1204, address data 1205, mirror node ID data 1206, and mirror slice ID data 1207, as shown in FIG. 5A.

Data of the ID of a disk node storing slice data is registered with the node ID data 1201. Since the slice of the meta data 1200 is stored in each of the disk nodes DP1, data “DP1” is registered with the node ID data 1201. Data of the ID of each of slices of the disk node of the node ID data 1201 is registered with the slice ID data 1202. In the above-described embodiment, data of slices SL1, SL2, SL3, and SL4 is registered with the slice ID data 1202. The slice SL1 corresponds to the slice 1101 of the disk node 110 shown in FIG. 4. Similarly, the slices SL2, SL3, and SL4 correspond to the individual slices 1102, 1103, and 1104.

Data of the slice assignment state is registered with the state data 1203. The sign “P” indicates a state assigned to a primary slice. The primary slice is included in the segment and the sign “S” corresponding thereto denotes a mirror destination. The sign “S” indicates a state assigned to a secondary slice. Both the secondary slice and the primary slice are included in the segment, and the sign “P” corresponding to the secondary slice denotes a mirror source. The sign “F” indicates that a slice is not assigned to any segment. Further, the signs “SP” and “R” are used. The sign “SP” indicates a single primary slice included in a degenerate segment, and there is no mirror slice corresponding to the single primary slice. The sign “R” indicates a reserved slice included in a segment recovering from redundancy. The sign “P” of a different disk node indicates the mirror source.

Data of the ID of the logical volume of a segment assigned to a slice is registered with the logical volume data 1204. In the above-described embodiment, data “L1” indicating the ID of the logical volume 1000 shown in FIG. 4 is registered with the logical volume data 1204.

Data of the head address to which a slice is assigned on the logical volume is registered with the address data 1205. Here, data of the ID of a segment may be registered with the address data 1205 in place of the address data. In the above-described embodiment, the address data items “A1” and “A2” of the logical volume 1000 shown in FIG. 4 are registered with the address data 1205.

Data of the ID of a disk node having the slice of a mirror destination (source) is registered with the mirror node ID data 1206. If the slice is indicated by the sign “P”, the slice is the mirror destination (data is mirrored from the slice P). If the slice is indicated by the sign “S”, the slice is the mirror source (data is mirrored to the slice S). In the above-described embodiment, data of different disk nodes “DP3” and “DP2” that are shown in FIG. 4 is registered with the mirror node ID data 1206.

Data of the ID of a slice of a mirror destination (source) is registered with the mirror slice ID data 1207. For example, the slice [L1-P1] 1101 identified by the node ID data “DP1” and the slice ID data “SL1” that are shown on the first line is in a state indicated by the sign “P (primary slice)”, which indicates that the slice [L1-P1] 1101 is assigned the segment [L1-A1] 1001 identified based on the logical volume data “L1” and the address data “A1”. Further, the above-described state data also indicates that the slice [L1-S1] 3102 of the disk 310 identified based on the disk node data “DP3” and the slice ID data “SL2” is assigned to the mirror destination. The above-described configuration goes for the second line.

(B) Data of the same items as those described above is registered for the meta data of the disk node DP2, as shown in FIG. 5B. For example, the slice [L1-P2] 2101 identified based on the node ID data “DP2” and the slice ID data “SL1” that are shown on the first line is in a state indicated by the sign “P (primary slice)”, which indicates that the slice [L1-P2] 2101 is assigned the segment [L1-A2] 1002 identified based on the logical volume data “L1” and the address data “A2”. Further, the above-described state also indicates that the slice [L1-S2] 1102 of the disk 110 identified based on the disk node data “DP1” and the slice ID data “SL2” is assigned to the mirror destination. The above-described configuration goes for the second line.

Thus, information about the state, a segment for assignment, the slice of a mirror destination (source) is registered with the meta data for each slice. The above-described information is dynamically updated in accordance with changing circumstances.

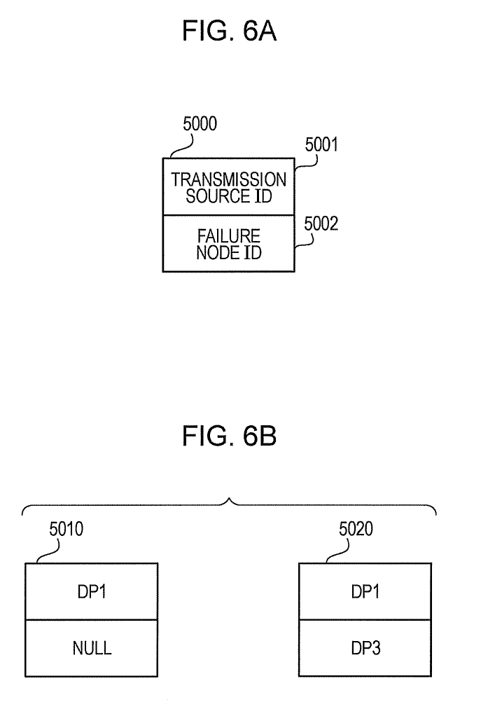

The broadcast will be described. FIG. 6A shows an exemplary format of the broadcast. FIG. 6B specifically shows an exemplary broadcast.

The broadcast is performed when the heartbeat transmission section 13 transmits HB data and the failure node determining section 15 issues a failure node candidate notification. The above-described method is used to transmit broadcast data to an unspecified large number of people. The transmitted broadcast data can be received by each of different apparatuses and/or devices connected to a network.

According to FIG. 6A, transmission source ID data 5001 and failure node ID data 5002 are set to a broadcast 5000 shown in a broadcast format. Data of the ID of a transmission source transmitting the broadcast is set to the transmission source ID data 5001. In the above-described embodiment, each of the disk nodes 100, 200, 300, and 400 can transmit the broadcast. Data of the ID of a detected failure node candidate is set to the failure node ID data 5002.

FIG. 6B shows a specific example of the broadcast. Usually, data of a broadcast 5010 is issued at the HB data transmission time. Data of the ID of a disk node that had transmitted the HB data is set to data shown as “transmission source ID”. At the HB data transmission time, data of “failure node ID” is shown as “NULL”. Upon receiving the broadcast 5010, the failure node detecting section 14 determines that no error occurs in the disk node set to the “transmission source ID”.

Data of a broadcast 5020 performed at the failure detection time is issued when the failure node determining section 15 transmits a notification about a failure node candidate. Data of the ID of a disk node that had detected the failure node candidate is set to the data “transmission source ID”. Further, data of the ID of a disk node determined to be the failure node candidate is set to the data “failure node ID”. Upon receiving the broadcast 5020, the data “failure node ID” is used by the failure node determining section 15, so as to determine whether or not the data “failure node ID” matches with data of the failure node candidate detected by the failure node determining section 15.

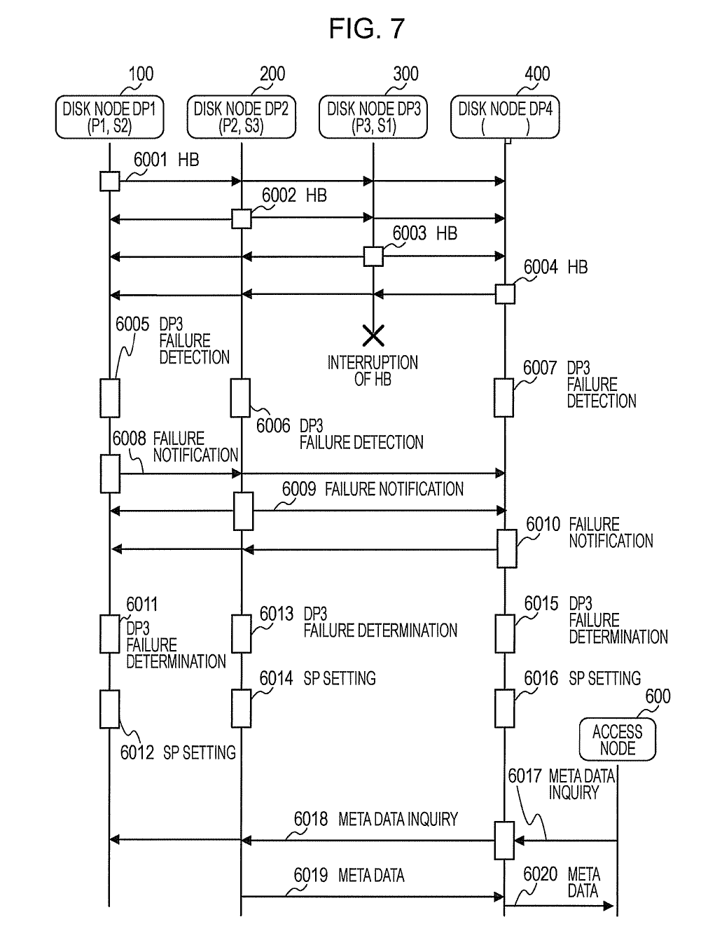

Failure node isolation processing operations and a failure node isolation method that are provided for the above-described multi-node storage system will be described in detail. FIG. 7 shows the operation sequence of the failure node isolation processing.

At the normal operation time, each of the disk nodes transmits HB data at predetermined intervals through a broadcast. When the disk node DP1 (100) transmits HB data 6001, each of the disk nodes DP2 (200), DP3 (300), DP4 (400) can receive the HB data 6001. Similarly, when the disk node DP2 (200) transmits HB data 6002, each of the disk nodes DP1 (100), DP3 (300), DP4 (400) can receive the HB data 6002. The above-described configuration goes for HB data items 6003 and 6004 of the individual disk nodes DP3 (300) and DP4 (400). Each of the disk nodes 100, 200, 300, and 400 determines that a disk node that can receive HB data is in a normal state.

If a failure occurs in the disk node DP3 (300) and the transmission of the HB data is interrupted, each of the different disk nodes 100, 200, and 400 detects that no HB data is transmitted from the disk node DP3 (300) over a predetermined time period. Then, each of the disk nodes 100, 200, and 400 detects the failure which had occurred in the disk node DP3 (300) (6005, 6006, and 6007).

Each of the disk nodes 100, 200, and 400 detecting the failure that had occurred in the disk node DP3 (300) issues a notification indicating that the disk node DP3 (300) is a failure node candidate. The disk node DP1 (100) transmits a failure notification 6008 through the broadcast 5020. Similarly, the disk node DP2 (200) transmits a failure notification 6009, and the disk node DP4 (400) transmits a failure notification 6010. Thus, each of the disk nodes 100, 200, and 400 receives the failure notifications that are transmitted from the different disk nodes, where the failure notifications indicate that the failure that had occurred in the failure node candidate “disk node DP3” detected by itself is detected by the different disk nodes.

The disk node DP1 (100) determines the failure that had occurred in the disk node DP3 (300) (6011), and determines a slice having the slice of the disk node DP3 (300) as a mirror destination and/or a mirror destination to be a single primary slice (SP) (6012). For the slice [L1-P1] 1101 held by the disk node DP1 (100), the disk node DP3 (300) is set as the mirror destination. Therefore, the state of the above-described slice is changed to a state indicated by the sign “SP”. Consequently, when a write request is issued for the slice [L1-P1] 1101, mirroring performed for the disk node DP3 (300) where the failure had occurred is stopped so that data writing can be appropriately performed.

Upon receiving the failure notification, the disk node DP2 (200) determines the failure that had occurred in the disk node DP3 (300) (6013), and determines a slice having the slice of the disk node DP3 (300) as the mirror destination and/or the mirror source to be the single primary slice (SP) (6014). Since the disk node DP3 (300) is determined to be the mirror source of the slice [L1-S3] 2102 held by the disk node DP2 (200), the above-described slice state is changed from the state “S” to the state “SP”. Consequently, if the slice [L1-S3] 2102 is determined to be the access destination, a read request and a write request can be executed appropriately.

Then, the disk node DP4 (400) determines the failure that had occurred in the disk node DP3 (300) (6015), and determines a slice having the slice of the disk node DP3 (300) as the mirror destination and/or the mirror source to be the single primary slice (SP) (6016). Since each of the slices of the disk node DP4 (410) is in the state “F”, the slice state is not changed.

Thus, each of the disk nodes 100, 200, and 400 autonomously performs the isolation processing for the disk node DP3 (300), and meta data managed by each of the disk nodes 100, 200, and 400 is updated. Here, if the access node 600 having the meta data that has yet to be updated by each of the disk nodes issues an access request for data stored in the slice [L1-P3] 3101 determined to be the primary slice of the disk node DP3 (300), the access request becomes an error request since the failure had occurred in the disk node DP3 and the access node 600 requests the meta data from the disk node. For example, the access node 600 makes a meta data inquiry 6017 about the slice [L1-P3] for the disk node DP4 (400). Since the disk node DP4 (400) does not have the above-described meta data, the disk node DP4 (400) makes a meta data inquiry 6018 through a broadcast. The meta data inquiry 6018 can be received by the disk node DP1 (100) and the disk node DP2 (200). Of the disk node DP1 (100) and the disk node DP2 (200), the disk node DP2 (200) having the meta data about the slice [L1-P3] transmits the updated meta data 6019 through a broadcast in return. Upon receiving the meta data 6019, the disk node DP4 (400) transmits updated meta data 6020 to the access node 600 in return so that the meta data of the access node 600 is updated. From then on, the access node 600 issues an access request to the disk node DP2 (200) based on the acquired meta data.

Thus, the meta data updated through each of the disk nodes can be transmitted to the access node without using the control node. Accordingly, access can be continued even though a permanently stationing control node is not provided.

In FIG. 7, the broadcast of the meta data inquiry 6018 is performed by the disk node. However, the access node 600 may directly make the meta data inquiry through a broadcast.

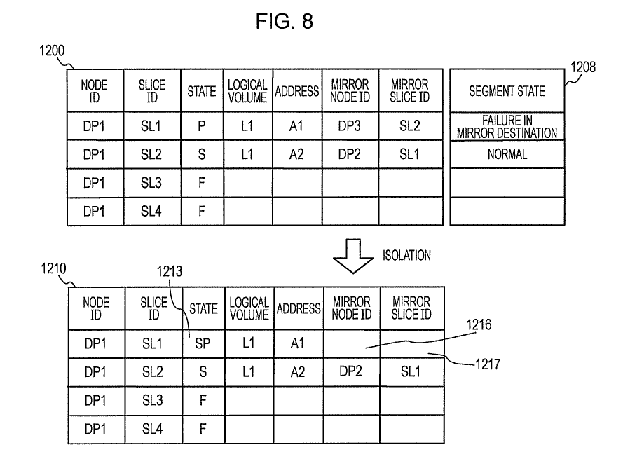

The isolation processing performed in the disk node DP1 (100) will further be described. FIG. 8 shows how the meta data is updated when the isolation processing is performed in the disk node DP1. The meta data 1200 of the disk node DP1 indicates meta data obtained before the isolation processing is performed in the disk node DP3 (300). Here, the slice “SL1” is a primary slice (P) and the disk node DP3 is specified as the mirror destination. Further, the slice “SL2” is a secondary slice (S) and the disk node DP2 is specified as the mirror source.

Here, if the disk node DP3 (300) is determined to be a failure node, segment state data 1208 indicates that the slice “SL1” enters a state “mirror destination failure”. The slice “SL2” remains in a state “normal”. Then, the isolation processing is performed for the slice of the lost mirror destination, and the meta data is updated. According to meta data 1210 of the disk node DP1 observed after the isolation processing is performed, the state of the slice “SL1” is changed to a single primary slice (SP) 1213. Since the slice “SL1” is determined to be the single primary slice (SP), mirror node ID data 1216 and mirror slice ID data 1217 are deleted.

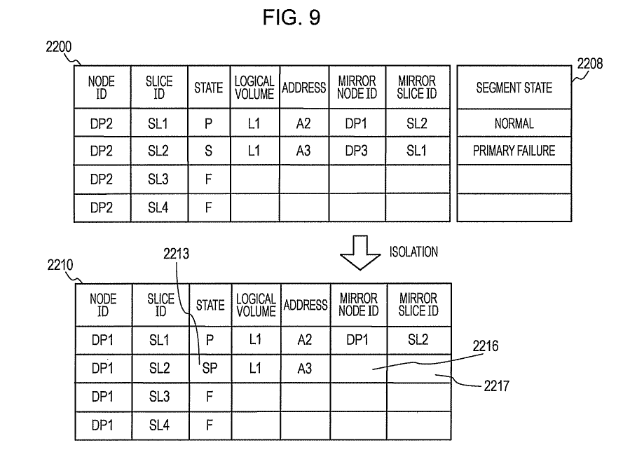

Next, the disk node DP2 (200) will be described in a like manner. FIG. 9 shows how the meta data is updated when the isolation processing is performed in the disk node DP2 (200). Meta data 2200 of the disk node DP2 indicates meta data obtained before the isolation processing is performed in the disk node DP3 (300). Here, the slice “SL1” is a primary slice (P) and the disk node DP1 is specified as the mirror destination. Further, the slice “SL2” is a secondary slice (S) and the disk node DP3 is specified as the mirror source.

Here, if the disk node DP3 (300) is determined to be a failure node, segment state data 2208 indicates that the slice “SL2” enters a state “primary failure” even though the state “normal” of the slice “SL1” is continued. Therefore, the disk node DP3 (300) becomes the primary slice in place of the lost primary slice, performs the isolation processing for the slice of the lost mirror source, and updates the meta data. According to meta data 2210 of the disk node DP2 observed after the isolation processing is performed, the state of the slice “SL2” is changed to a single primary slice (SP) 2213. Since the slice “SL2” is determined to be the single primary slice (SP), mirror node ID data 2216 and mirror slice ID data 2217 are deleted.

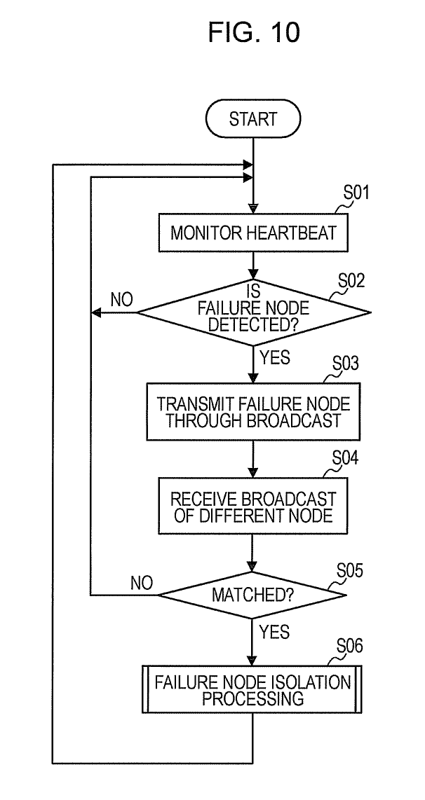

Hereinafter, the procedures of the failure node detection and the failure node isolation processing performed by the disk node will be described with reference to a flowchart of FIG. 10.

[Step 801] The disk node transmits HB data to a different disk node at predetermined intervals through a broadcast. Further, the disk node receives the HB data transmitted from the different disk node and monitors whether or not the HB data transmitted from the different disk node is interrupted over a predetermined time period.

[Step 802] The disk node determines whether or not a failure node, which interrupts the transmission of the HB data over a predetermined time period, is detected. If the failure node is detected, the processing advances to step S03. Otherwise, the processing returns to step S01 so as to continue the HB data monitoring.

[Step S03] When the failure node is detected, the disk node transmits data of the ID of the failure node through a broadcast so as to notify the different disk node of the detected failure node. [Step S04] The disk node receives the broadcast indicating the ID data of the failure node, the ID data being transmitted from the different disk node. The disk node waits until the disk node receives the broadcast transmitted from each of a predetermined number of disk nodes so as to notify the ID of the failure node. The predetermined number is arbitrarily determined so that the number indicates that of all of different disk nodes except the failure node and a node of its own.

[Step S05] The disk node determines whether or not the failure ID notified by the different disk node through the broadcast matches with the failure node detected by the own node. If the above-described nodes match with each other, the processing advances to step S06. Otherwise, the processing returns to step S01 so that the processing is performed from the heartbeat monitoring.

[Step S06] If the failure node detected by the own node matches with the failure node detected by the different disk node, the disk node determines the above-described disk node to be the failure node and performs the failure node isolation processing. After the failure node isolation processing is finished, the processing returns to step S01 so that the processing is performed again from the heartbeat monitoring.

Performing the above-described processing procedures allows the disk nodes to detect failures for each other based on the HB data items transmitted at the regular intervals, and isolate the detected failure node. Consequently, the failure node is isolated through the use of the disk node alone, which makes it possible to continue access made by the access node even though a permanently stationing control node is not provided.

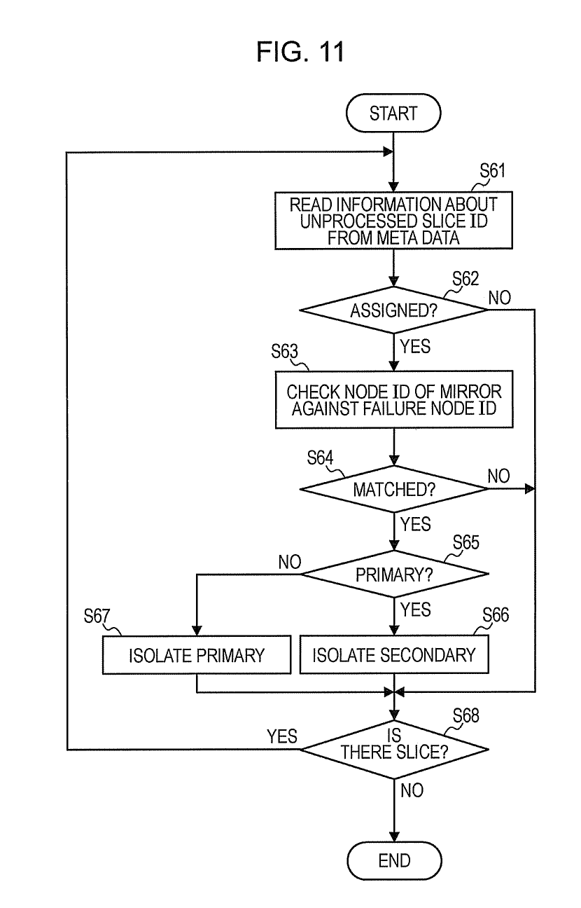

Next, the failure node isolation processing will be described. FIG. 11 is a flowchart showing the procedures of the failure node isolation processing. Data of the ID of the detected failure node is acquired, and the processing is started.

[Step S61] The disk node reads information about the ID of an unprocessed slice from the meta data by as much as a single line. Then, the disk node extracts data of “state”, “mirror node ID” that are assigned to the slice. [Step S62] The disk node checks the data “state” of the above-described slice, and determines if any segment is assigned to the slice. If a segment is assigned (state=P and/or S), the processing advances to step S63. If no segment is assigned (state=F), the processing advances to step S68.

[Step S63] If any segment is assigned to the slice, the disk node checks the data “mirror node ID” against data of the ID of the detected failure node. [Step S64] If the result of checking performed at step S63 shows that the mirror node ID data matches with the failure node ID data, the processing advances to step S65 so that the mirror node isolation processing is performed. Otherwise, the processing advances to step S68.

[Step S65] When the mirror node ID data matches with the failure node ID data, the disk node determines whether the data “state” of the above-described slice indicates a primary slice (P) or a secondary slice (S). If the primary slice (P) is indicated, the processing advances to step S66. If the secondary slice (S) is indicated, the processing advances to step S67.

[Step S66] If the slice is the primary slice (P), the disk node isolates the mirror node in which the failure had occurred and stops mirror writing performed for the secondary slice (S) assigned to the mirror node. More specifically, the data “state” corresponding to the above-described slice of the meta data is changed to the single primary slice (SP) and the registration of the mirror node ID data and the mirror slice ID data is deleted. Then, the processing advances to step S68.

[Step S67] If the above-described slice is the secondary slice (S), the disk node changes the own node to the primary slice (P). The disk node isolates the mirror node where the failure had occurred and stops mirror writing performed for the previous primary slice (P) assigned to the above-described mirror node. More specifically, the disk node changes the data “state” corresponding to the above-described slice of the meta data to the single primary slice (SP) and deletes the registration of the mirror node ID data and the mirror slice ID data.

[Step S68] The disk node determines whether or not the meta data includes data of an unprocessed slice. If the meta data includes the above-described data, the processing returns to step S61 so that the next slice is processed. Otherwise, the processing is terminated. Performing the above-described processing procedures allows for isolating the primary slice and/or the secondary slice of a segment that is lost due to a failure that occurs in the disk node and determining a normal slice to be the single primary slice. Consequently, it becomes possible to determine the single primary slice to be the access destination and continue access made by the access node.

The above-described technologies allow computers managing real data storage areas to monitor the states for one another, and isolate a failure node autonomously when the failure node is detected. Consequently, the failure node can be isolated without using the control node and access is restarted even though the failure node is stopped. As a result, the service continuity can be increased.

The above-described processing functions can be implemented by a computer. In that case, a program describing the details of processing functions that should be provided for a storage node included in a storage system is presented. The program is executed by the computer so that the above-described processing functions are implemented on the computer. The program describing the details of the processing functions can be stored in a computer readable recording medium.

For making the program commercially available, a portable recording medium storing the above-described program is sold, where the portable recording medium includes, for example, a digital versatile disk (DVD), a compact disk read only memory (CD-ROM), and so forth. Further, the program may be stored in the storage of a server computer so that the program is transferred from the server computer to a different computer via a network.

The computer executing the program stores the program stored in the portable recording medium and/or the program transferred from the server computer in the storage of its own. Then, the computer reads the program from the storage of its own, and performs processing based on the program. Here, the computer can directly read the program from the portable recording medium and perform processing based on the program. Further, each time the program is transferred from the server computer, the computer can execute processing based on the transferred program.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A computer-readable recording medium encoded with a failure node isolation program containing instructions executable on a first computer, the first computer being a storage system where data is distributed and stored in a plurality of storage devices, upon a failure occurring in at least one second computer, of one or more second computers, managing a real data storage area of the storage device, the first computer isolating the at least one second computer, the program causing the first computer to execute:
an access processing procedure in which each of a plurality of slices, obtained by dividing the real data storage area of the storage device by segments, is assigned to each of a plurality of segments obtained by dividing a virtual logical volume into a primary slice storing data of the respective segment as a destination of access made by an access node and a secondary slice that mirrors and stores data of the primary slice, management information associating each segment with the respective primary slice and the respective secondary slice being stored in a recording unit and an access request transmitted from the access node being processed based on the management information;
a failure node detecting procedure in which a survival signal transmitted at predetermined intervals while the at least one second computer is normally operating is monitored and the at least one second computer from which the survival signal is not detected over a predetermined time period is detected as a failure node; and
a failure node isolation procedure in which the failure node is checked against the management information, and when a slice to be managed is associated with a slice managed by the failure node, the slice to be managed is set as a single primary slice that is an access destination of the access node and for which the mirroring is stopped and the failure node is isolated.

2. The computer-readable recording medium according to claim 1, wherein, at the failure node isolation procedure, the information is searched and the slice to be managed, the slice being associated with the slice managed by the failure node, is extracted, and when the slice to be managed is the primary slice, the slice is changed to the single primary slice and the mirroring is stopped, and when the slice is the secondary slice, the slice is changed to the single primary slice and an access destination of the access node and the mirroring is stopped.

3. The computer-readable recording medium according to claim 1, the program further causing the first computer to execute:
a survival signal transmission procedure where the survival signal is transmitted to the at least one second computer through a broadcast at the predetermined intervals when the access processing performed through the access processing procedure can be executed.

4. The computer-readable recording medium according to claim 1, the program further causing the first computer to execute:
a failure node determining procedure in which the failure node detected at the failure node detecting procedure is determined to be a failure node candidate, a notification about the failure node candidate is transmitted to the at least one second computer, a notification about the failure node candidate, the notification being transmitted from the at least one second computer, is received, failure node candidate data extracted from the notification is checked against data of the failure node candidate detected by itself, and the failure node candidate is determined to be the failure node only when the extracted failure node candidate data matches with the detected failure node candidate data.

5. The computer-readable recording medium according to claim 4, wherein, at the failure node determining procedure, the failure node candidate notification transmitted from each of the one or more second computers except the failure node are received, and the failure node candidate is determined to be the failure node only when the failure node candidate data extracted from each of the notifications matches with the detected failure node candidate.

6. The computer-readable recording medium according to claim 4, wherein the failure node candidate notification is transmitted to the at least one second computer through the broadcast.

7. The computer-readable recording medium according to claim 1, wherein, at the access processing procedure, upon receiving a request to read management information corresponding to a specified segment requested by specifying the segment, the read request being transmitted from the access node, the management information stored in the storage unit is searched for the management information corresponding to the specified segment, the management information corresponding to the specified segment is transmitted to the access node when the management information is obtained through the search, a request to read the management information corresponding to the specified segment is transmitted to the at least one second computer when the management information is not obtained through the search, and the management information corresponding to the specified segment acquired from the least one second computer having the management information corresponding to the specified segment to the access node.

8. The computer-readable recording medium according to claim 7, wherein, at the access processing procedure, a request to read the management information corresponding to the specified segment, which is transmitted to the at least one second computer, is transmitted through a broadcast, the request to read the management information corresponding to the specified segment is acquired through a broadcast, and the management information is transmitted through a broadcast when the management information is held.

9. A failure node isolation method provided for a storage system in which data is distributed and stored in a plurality of storage devices so that when a failure occurs in at least one computer, of one or more computers, managing a real data storage area of the storage device, the at least one computer is isolated, the program comprising:
assigning each of a plurality slices, obtained by dividing the real data storage area of the storage device by segments, to each of a plurality of segments obtained by dividing a virtual logical volume into a primary slice storing data of the respective segment as a destination of access made by an access node and a secondary slice that mirrors and stores data of the primary slice;
storing management information associating each segment with the respective primary slice and the respective secondary slice in a recording unit;
processing an access request transmitted from the access node based on the management information;
monitoring a survival signal transmitted at predetermined intervals while the at least one computer is normally operating and detecting the at least one computer from which the survival signal is not detected over a predetermined time period as a failure node; and
checking the failure node against the management information and setting a slice to be managed as a single primary slice that is an access destination of the access node and for which the mirroring is stopped when the slice to be managed is associated with the slice managed by the failure node, and isolating the failure node.

10. A storage system in which data is distributed and stored in a plurality of storage devices, the system comprising:
a plurality of storage nodes each comprising:
a recording unit in which each of a plurality of slices, obtained by dividing a real data storage area of the respective storage device by segments, is assigned to each of a plurality of segments obtained by dividing a virtual logical volume into a primary slice storing data of the respective segment as a destination of access made by an access node and a secondary slice that mirrors and stores data of the primary slice, management information associating each segment with the respective primary slice and the respective secondary slice being stored;
an access processing unit configured to process an access request transmitted from the access node based on the management information;
a failure node detecting unit that monitors a survival signal transmitted at predetermined intervals while the at least one computer is normally operating and detects the at least one computer from which the survival signal is not detected over a predetermined time period as a failure node; and
a failure node isolation unit configured to check the failure node against the management information and set a slice to be managed as a single primary slice that is an access destination of the access node and for which the mirroring is stopped, and isolate the failure node when the slice to be managed is associated with the slice managed by the failure node, wherein
the access node is configured to acquire the management information from the storage node, determine the storage node of an access destination based on the management information, and issue an access request to the determined storage node.
